(19) United States
(12) Patent Application Publication
(10) Pub. No.: US 2019/0390496 A1
(43) Pub. Date: Dec. 26, 2019

(54) System for Automatically Closing/Opening a Sliding Door or Shutter

(71) Applicant: IN & TEC S.R.L., Brescia (BS) (IT)

(72) Inventor: Luciano Bacchetti, Nave (BS) (IT)

(21) Appl. No.: 16/481,399

(22) PCT Filed: Feb. 2, 2018
(86) PCT No.: PCT/IB2018/050671

§ 371 Date: Jul. 26, 2019

(30) Foreign Application Priority Data
Feb. 2, 2017 (IT) 102017000011606

(51) Int. Cl. E05F 3/10; E05D 15/06; E05F 1/16; E05F 3/02; E05F 3/12

(52) U.S. Cl. CPC E05F 3/10; E05D 15/0626; E05Y 2900/132; E05F 3/02; E05F 3/12; E05F 1/16

(57) ABSTRACT

A system for the automatic closing/opening of an aperture includes closing element slidable in a plane between a closing position, in which it closes the aperture, and an opening position, in which the aperture is open; and a linear actuator operatively coupled to the closing element to automatically return it from one of the open or closed positions to the other one of the open or closed positions. The linear actuator includes a jacket defining an axis and a rod (20) slidable in relation to the jacket. The linear actuator includes a stationary element and a movable element, one of which includes the jacket and the other one includes the rod. The system further includes a guide rail, in which the movable element of the linear actuator slides, and which defines a sliding direction substantially parallel to the axis.

### FIELD OF THE INVENTION

The present invention is generally applicable to the technical field of the moving systems and particularly relates to a system for the opening/closing of an aperture including a linear actuator unitary slidable with a door, a door leaf or the like.

### STATE OF THE ART

It is known that there are two main kinds of linear actuators, hydraulic or pneumatic ones.

In both cases, the actuator must be connected to a supply line of a working fluid, either oil or compressed air.

This implies the undoubted drawback of having a working fluid to manage, with all the related problems. As a consequence, these kinds of actuators are unsuitable for several non-industrial applications, for example the movement of a sliding door or a door leaf.

Compression and traction gas springs are known too. In these kinds of springs a gas, generally nitrogen, is used to bring the rod back to its rest position once it is pushed or pulled into the working position.

A known drawback of these kinds of springs is that they tend to discharge over time, forcing them to be periodically replaced. Moreover, since the rod works against a gas as the rod is compressed or pulled, the pressure of the gas increases, and as a result the force necessary to move the rod increases.

### SUMMARY OF THE INVENTION

The object of the present invention is to overcome at least partially the above mentioned drawbacks, by providing a linear actuator having characteristics of high functionality, simplicity of construction and being low cost.

Another object of the invention is to provide a system for opening/closing a sliding door or door leaf which always requires the same force to move the latter, regardless of the position of the latter.

Another object of the invention is to provide a system for opening/closing a sliding door or door leaf which requires minimal maintenance.

Another object of the invention is to provide a system for opening/closing a sliding door or door leaf of contained overall dimensions.

Another object of the invention is to provide an actuator which ensures the automatic closing/opening of a door or a door leaf from the open/closed position.

Another object of the invention is to provide a system for opening/closing a sliding door or door leaf which ensures the controlled movement of the latter.

Another object of the invention is to provide a system for opening/closing a sliding door or door leaf which has a minimum number of constituent parts.

These objects, as well as others that will appear more clearly in the following, are achieved by an opening/closing system of a closure element in accordance with what is herein described, shown and/or claimed.

The dependent claims describe advantageous embodiments of the invention.

### BRIEF DESCRIPTION OF THE DRAWINGS

Further features and advantages of the invention will be more evident considering the detailed description of some preferred but not exclusive embodiments of a system 1, shown by way of a non-limiting example with the aid of the accompanying drawings, wherein:

FIGS. 1a and 2a are schematic views of an embodiment of the system 100 for closing an aperture P by means of a sliding door D moved by a preferred non-exclusive embodiment of a linear actuator 1, respectively in the closed door position D and the open door position D;

FIGS. 1b and 2b are schematic views of the embodiment of the linear actuator 1 of FIGS. 1a and 2a respectively in the closed door position D and open door position D;

FIG. 3 is an exploded view of the embodiment of the linear actuator 1 of FIGS. 1a and 2a;

FIGS. 4a and 4b are respectively views in section of the ends 13″ and 13′ of the tubular element 11 of the embodiment of the linear actuator 1 of FIGS. 1a and 1b in the closed door position D;

FIG. 5 is a sectional view of the end 13″ of the tubular element 11 of the embodiment of the linear actuator 1 of FIGS. 2a and 2b in the open door position D;

FIG. 6 is a sectional view of the end 13″ of the tubular element 11 of a further embodiment of a linear actuator 1 having the end 22 in a distal position;

FIG. 7 is a sectional view of the end 13′ of the tubular element 11 of the further embodiment of the linear actuator 1 of FIG. 6 having the end 22 in proximal position;

FIGS. 8a and 8b are enlarged schematic views of the embodiment of the system 100 of FIGS. 1a and 2a, showing the linear actuator 1 in the closed door position D and the open door position D;

FIGS. 9a and 9b are sectional views of the embodiment of the linear actuator 1 shown in FIGS. 8a and 8b respectively in closed door position D and open door position D;

FIG. 10 is an exploded view of another embodiment of the linear actuator 1;

FIGS. 11A and 11B are sectional views of the embodiment of the linear actuator 1 of FIG. 10 with the door leaf D respectively in closed and open position;

FIG. 12 is an exploded view of a second embodiment of the linear actuator 1;

FIGS. 13A and 13B are sectional views of the embodiment of the linear actuator 1 of FIG. 12 with the door leaf D respectively in closed and open position.

### DETAILED DESCRIPTION OF SOME PREFERRED EMBODIMENTS

With reference to the mentioned figures, a linear actuator 1 is described, adapted to linearly move any object, mechanism or system. The linear actuator can act directly or indirectly, by means of pulleys or referral mechanisms.

In a preferred but not exclusive embodiment of the invention, the linear actuator 1 can be used in a system 100 for closing/opening an aperture P by means of a closing element D movable between an open position and a closed position.

In general, the aperture P may be any opening made in any stationary supporting structure, and the closing element D may be of any kind such as e.g. a door, a door leaf, a hatch, a trap-door or the like. Likewise, the closing element D can move with any motion, rectilinear along a sliding plane or rotary around a rotation axis.

In the latter case, the linear actuator 1 may act as a door closer or a hinge device, or it may be an integral part of it. The closing element D may be a door, a door leaf or the like.

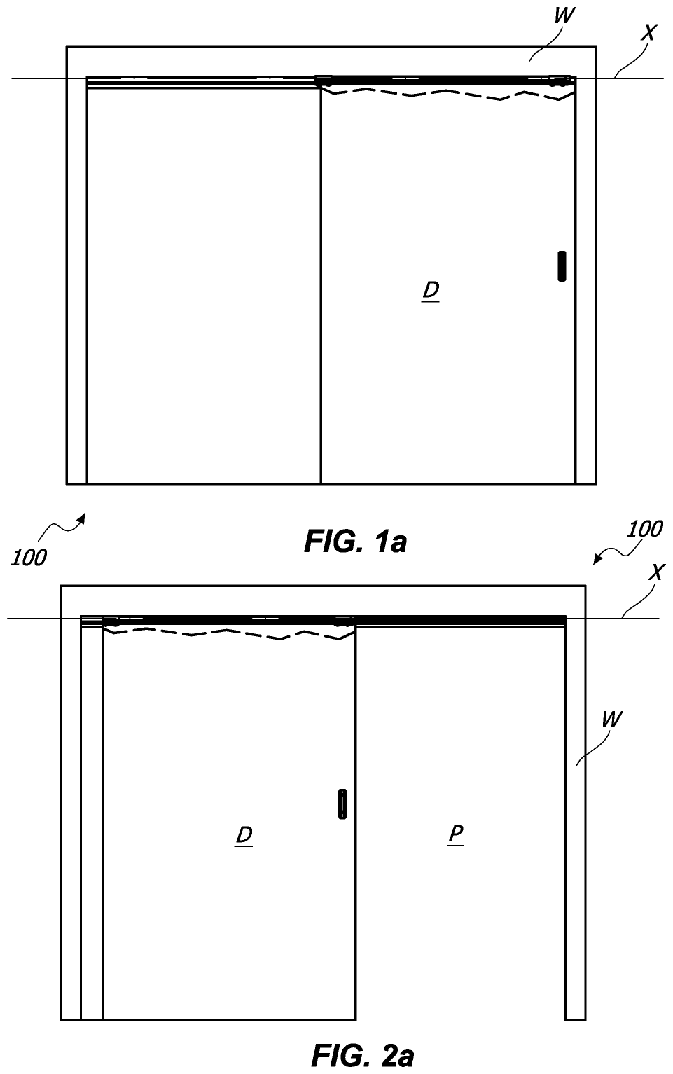

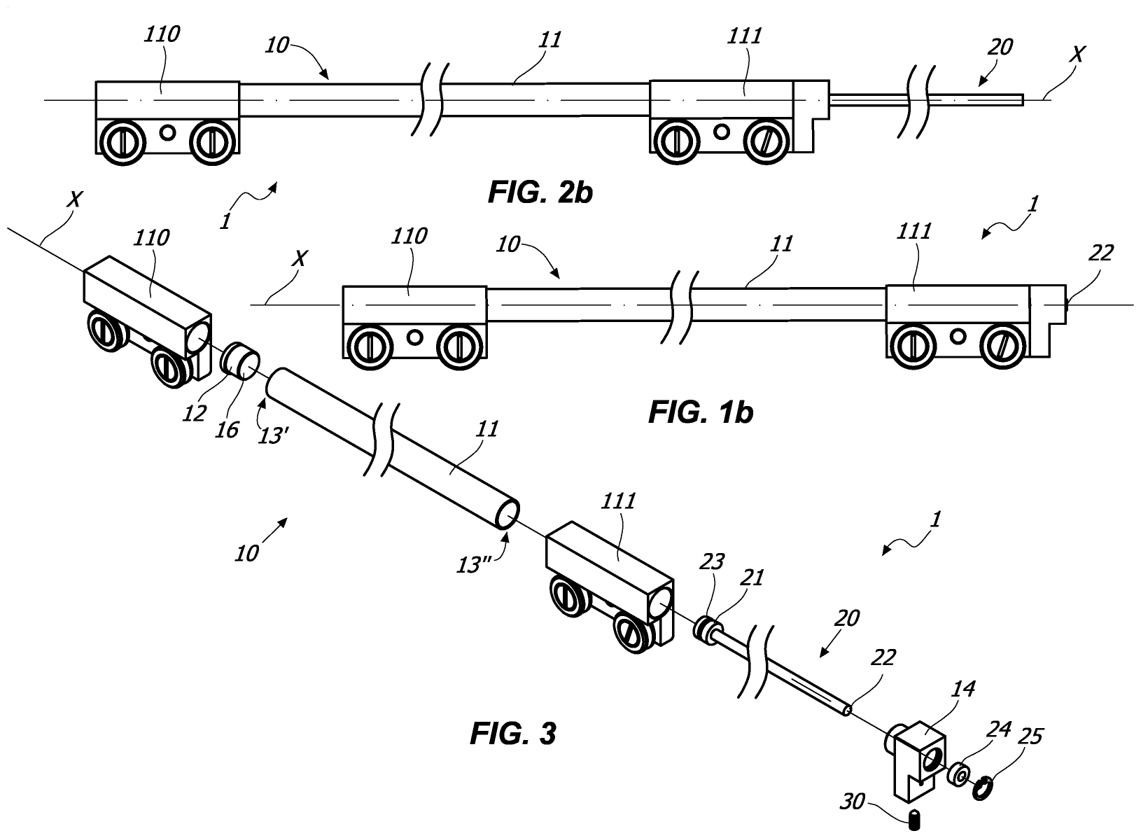

For example, as shown in FIGS. 1a and 2a, the aperture P may be a passage made in a wall W, and the closing element D may be a sliding door in a plane defined by the door itself between a closed position, shown in FIG. 1a, and an open position, shown in FIG. 2a. Preferably, in the latter position the closing element D may be fully open.

FIGS. 1b and 2b respectively show the linear actuator 1 in the positions corresponding to those of FIGS. 1a and 2a.

On the other hand, the aperture P may be a passage made in a frame, for example a frame of a refrigerated counter, and the closing element D may be a sliding door leaf.

In general, the linear actuator 1 may comprise a jacket 10 defining an axis X and a rod 20 movable therefrom between a retracted position, shown for example in FIG. 1b, and an extended position, shown for example in FIG. 2b.

Even if, in the following, the jacket 10 is described as a movable element with respect to the stationary rod 20, it is understood that the opposite can also occur, i.e. the rod may move in relation to the stationary jacket, without thereby exceeding the scope of protection of the appended claims.

It is also understood that even if in the shown embodiments a single rod 20 and a single jacket 10 are provided, the linear actuator 1 may include a plurality of jackets and/or a plurality of rods, as it can be coupled to other actuators, for example gas springs of a known type, without thereby exceeding the scope of protection of the appended claims.

In any case, the mobile element of the linear actuator 1, the jacket 10 in the embodiment shown in the appended figures, may be connected to the sliding door D, while the stationary element, the rod 20 in the embodiment shown in the appended figures, may be fixed to the wall W.

Therefore, the jacket 10 will slide unitary with the door between the open and closed positions thereof.

For this purpose, slider means may be provided, for example two or more slides 110, 111, operatively engaged in one or more guiding rails 120 defining a sliding direction d substantially parallel to the axis X defined by the jacket.

Advantageously, the slides 110, 111 can be coupleable to the tubular element 11 of the linear actuator 10, for example slidably inserted thereon.

In this way, a compact, simple to realize and functional linear actuator is obtained.

These features allow it to be concealedly into a lengthened or C-shaped inferiorly opened tubular 130, which can be inserted into the door frame or into a false ceiling, or be an integral part of them.

Preferably, the profile 130 with the linear actuator 1 may be positioned above a sliding door D. On the other hand, it may also be positioned laterally to the door D or even below it, using suitable return means such as for example pulleys and ropes.

The linear actuator 1 usable in the system 100 may be of any type.

In a preferred but not exclusive embodiment of the system 100, particularly shown in FIGS. 3 to 7, the actuator 1 may have the characteristics described below.

Even if in the rest of the description a linear actuator 1 is described for moving the sliding door D, it is understood that the linear actuator 1 can have any use without thereby exceeding the scope of protection of the appended claims.

As mentioned above, in the present description the notion of sliding between the rod 20 and the jacket 10 and the relative parts must be understood in a relative and not absolute manner. Therefore, even if for simplicity the sliding of the rod 20 with respect to the jacket 10 is to be cited, it must be understood that the sliding between these parts is reciprocal and relative to each other.

In the embodiment shown in FIGS. 1a to 5 the retracted position of FIG. 1b, corresponding to the closed door position D, corresponds to the rest position of the linear actuator 1, i.e. the one in which the linear actuator 1 itself is not stressed by external forces.

On the other hand, the extended position of FIG. 2b, corresponding to the open door position D, corresponds to the working position of the linear actuator 1, i.e. the one wherein the linear actuator 1 is stressed by the force that the user gives to the door to open it. From this position the linear actuator 1 automatically closes the door D, or, what is the same, the linear actuator 1 automatically returns to its rest position.

In this embodiment, therefore, the linear actuator 1 works in traction.

Advantageously, the rod 20 may include an end cylinder 21 and an opposite end 22, both naturally unitary slidable with each other along the axis X by the rod 20. The end cylinder 21, therefore, will slide between the rest and working positions.

It is understood that in the case of a curved or suitably shaped rod the end 22 may slide along an axis substantially parallel to the X axis without thereby departing from the scope of protection of the appended claims.

The end cylinder 21 may tightly slide inside the jacket 10 by means of a gasket 23, of a known type. The opposite end 22 may slide outwardly of the jacket 10 between a position proximal to this, corresponding to the rest position shown in FIG. 1b, and a distal position thereof, corresponding to the working position shown in FIG. 2b.

The jacket 10 may include a tubular element 11 defining the side wall thereof, an end cap 12 tightly screwed at the end 13′ of the tubular element 11 and a closing element 14 tightly screwed at the other end 13″ of the tubular element 11.

The rod 20 may be inserted through an opening 15 passing through a wall 14′ of the closing element 14.

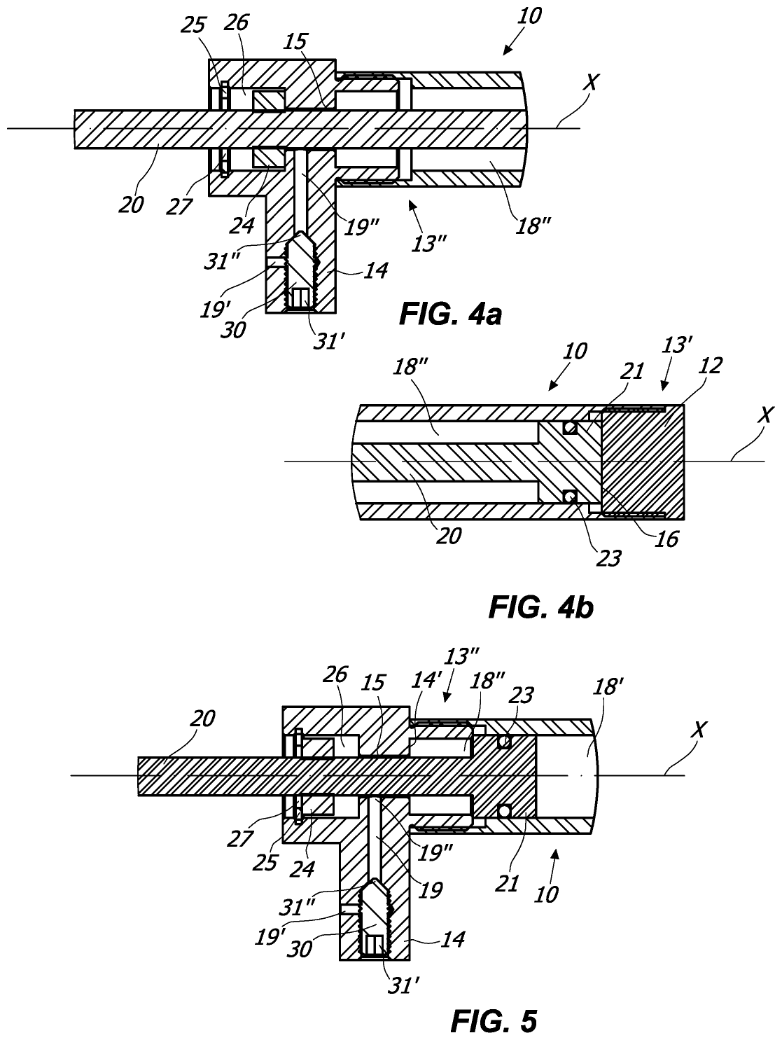

Advantageously, the rod 20 and the tubular element 11 may be mutually configured so that when the end 22 is in the proximal rest position, shown for example in FIG. 1b, the bottom wall 16 of the end cap 12 contacts the end cylinder 21, as particularly shown in FIG. 4b.

The end cylinder 21 may divide the jacket 10 into a first and second variable volume compartments 18′, 18″ fluidically independent to each other, i.e. compartments which are not fluidically connected to each other and which don't exchange any fluid.

When the end 22 is in the rest position, as shown for example in FIG. 1b, the variable volume compartment 18′ has the minimum volume while the variable volume compartment 18″ has the maximum volume, while the opposite occurs when the end 22 is in the working position, as shown for example in FIG. 2b.

Since the end cap 12 is tightly screwed into the tubular element 11 and the end cylinder 21 is tightly inserted in the latter, the compartment 18′ is fluidically insulated, i.e. any fluid can't enter/exit in/from the same.

On the other hand, since when the end 22 is in the rest position, shown for example in FIG. 1b, the bottom wall 16 of the end cap 12 is in contact with the end cylinder 21, as particularly shown in FIG. 4b, the compartment 18′ is under vacuum. In this position, therefore, the volume of the compartment 18′, corresponding to its minimum volume, is substantially zero, like the pressure inside it.

To this end, the screwing of the end cap 12 may take place when the end cylinder 21 is already at the end 13′ of the tubular element 11. This occurs when the end 22 is in the proximal rest position, shown for example in FIG. 1b. By inserting the end cylinder 21 through the end 13″, in fact, it is possible to substantially expel all the air from the compartment 18′, which is then plugged with the end cap 12.

In this way, it is ensured that the compartment 18′ remains under vacuum without the aid of external vacuum pumps or means.

It is understood, however, that it may be possible to place the compartment 18′ under vacuum in any way, for example by connecting it to external pumps or vacuum means, without thereby departing from the scope of protection of the appended claims.

Advantageously, the compartment 18″ may be fluidically communicating with the outside environment. In this way, the compartment 18″ may be at atmospheric pressure, that is at the pressure of the outside environment.

For the above, in the closed door position shown in FIG. 1a the end cylinder 21 remains against the bottom wall 16 of the end plug 12, and therefore the end 22 remains in the rest position proximal to the jacket 10.

Once a user opens the sliding door D, i.e. upon the movement of the end 22 from the rest position proximal to the jacket 10 to the working position distal therefrom, the compartment 18′ expands increasing in volume up to a maximum volume, while the compartment 18″ contracts decreasing in volume up to a minimum volume.

In doing so, the user works against the vacuum present in the compartment 18′, which guarantees that the same force will always be required to open the sliding door D regardless of its position. At the same time, the compartment 18″ discharges the air present therein into the outside environment.

Once the user leaves the door D in the open position, the vacuum present in the compartment 18′ will suck the rod 20 automatically returning the end 22 towards the rest position proximal to the jacket 10, returning the end cylinder 21 against the end cap 12 and automatically closing the sliding door D. As a consequence, the compartment 18″ will be charged with air coming from the outside environment.

Due to the fact that the compartment 18′ is considered empty, the linear actuator 1 guarantees the constancy of the force required to open/close the door D from its position.

It is also evident that the linear actuator 1 is extremely functional and it's simple and economical to build and assemble.

In fact the assembly will take place as described above by inserting the rod 20 through the tubular element 11, screwing the end cap 12 at the end 13′ of the latter as mentioned above to obtain an under vacuum compartment 18′, and screwing the closing element 14 in correspondence of the opposite end 13″ after insertion of the same on the end 22 of the rod 20 through the opening 15.

The assembly will then be completed by fitting the elastomeric membrane 24 on the rod 20 and inserting it into the seat 26, blocking the axial movement of the latter by means of a stop ring 25, which may be for example a Seeger ring.

Since the construction parts are minimal, like those in reciprocal movement, the linear actuator will require minimal maintenance and will guarantee a long service life.

The dimensions of the linear actuator 1 are minimal, making it suitable for any application, for example to move sliding doors or sliding door leaves, as better described below.

The simplicity of the linear actuator 1 will always guarantee the automatic closing/opening of the door or leaf from the open/closed position.

In a preferred but not exclusive embodiment of the invention, the closure element 14 may include means for controlling the air flow flowing in/out from the variable volume compartment 18″, so as to control the force necessary to open the sliding door D and the closing speed thereof.

It is understood that the control means may also be configured only for one of the functions mentioned above, and in particular for controlling the force necessary for the movement of the cylindrical element 21 from the rest position to the working position or to control the speed of aspiration of the same towards the closed position, without thereby exceeding the scope of protection of the appended claims.

For this purpose, in general, a first and second line for the fluidic connection of the variable volume compartment 18″ with the outside environment and valve means acting on them may be provided.

In the embodiment shown in FIGS. 1a to 5, a first fluid connecting line can be defined by a portion of the passing-through opening 15 and by the duct 19.

In this fluid connecting line upon the movement of the end cylinder 21 from the rest position to the working position, the air present in the compartment 18″ will pass through the passing-through opening 15, entering the duct 19 through the opening 19″ and going out through the exit 19′. It is evident that upon the aspiration of the end cylinder 21 from the working position to the rest position, the air will make the reverse movement, entering through the opening 19′ to reach the expanding compartment 18″.

On the other hand, the second fluid connecting line may be defined by the opening 15, by the seat 26 and by the annular gap 27 between the stop ring 25 and the rod 20.

In this fluid connecting line upon the movement of the end cylinder 21 from the rest position to the working position, the air present in the compartment 18″ will reach the exit 27 upon the movement through the passing-through 15 and the seat 26, while upon the aspiration of the end cylinder 21 from the working position to the rest position, the air will do the reverse movement, entering through the annular gap 27 to reach the expanding compartment 18″.

The valve means may be defined by the seat 26 which will act as a valve seat for the axial movement of the elastomeric membrane 24, which will act as a plug for the passing-through 15 upon the aspiration of the end cylinder 21 from the working position to the rest position and will rest against the stop ring 25 upon the movement of the end cylinder 21 from the rest position to the working position, in any case allowing the flow of the air.

In other words, during the opening of the sliding door D, the air present in the contracting compartment 18″ will be free to pass both through the duct 19 and through the annular gap 27, while during the closing of the sliding door D the air will pass exclusively through the duct 19 to reach the expanding compartment 18″.

By suitably dimensioning the above parts it will be possible to control both the force required to open the sliding door D and the closing speed thereof. In particular, the force required to open the sliding door D may be determined by the diameter of the end cylinder 21.

In order to adjust the latter, suitable adjustment means may be provided, for example an adjustment grain 30, for adjusting the flow section. In this way, it will be possible to adjust the inflow of air entering the duct 19 through the opening 19′ upon the aspiration of the end cylinder 21 from the working position to the rest position, thus regulating the returning speed to the closed position of the sliding door D.

For this purpose, the adjustment grain 30 may have a control end 31′ accessible from the outside by an operator and a working end 31″ acting in the duct 19.

It is understood that the control means described above can be applied to any linear actuator, preferably of pneumatic type, without thereby departing from the scope of protection of the appended claims.

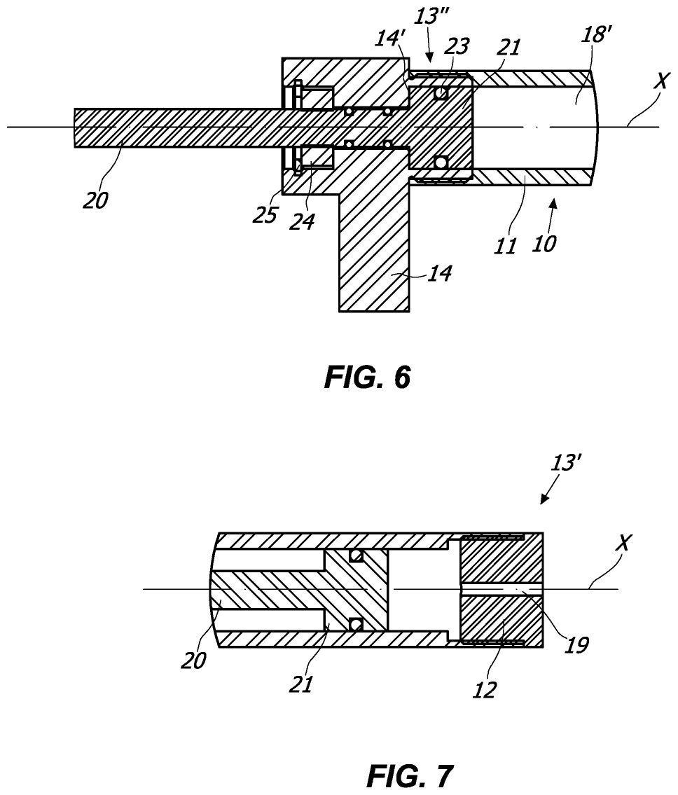

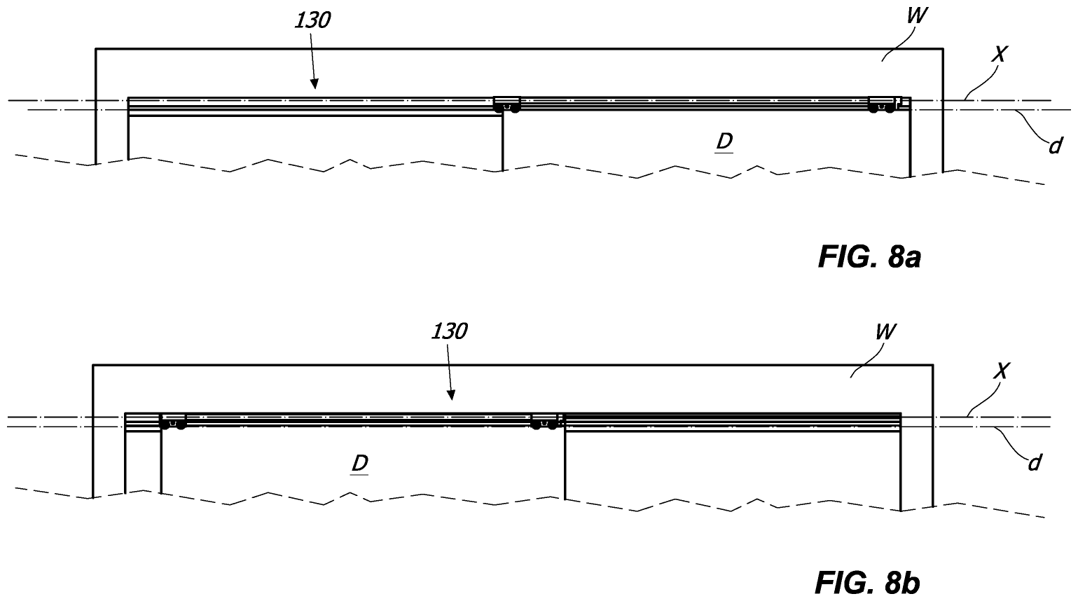

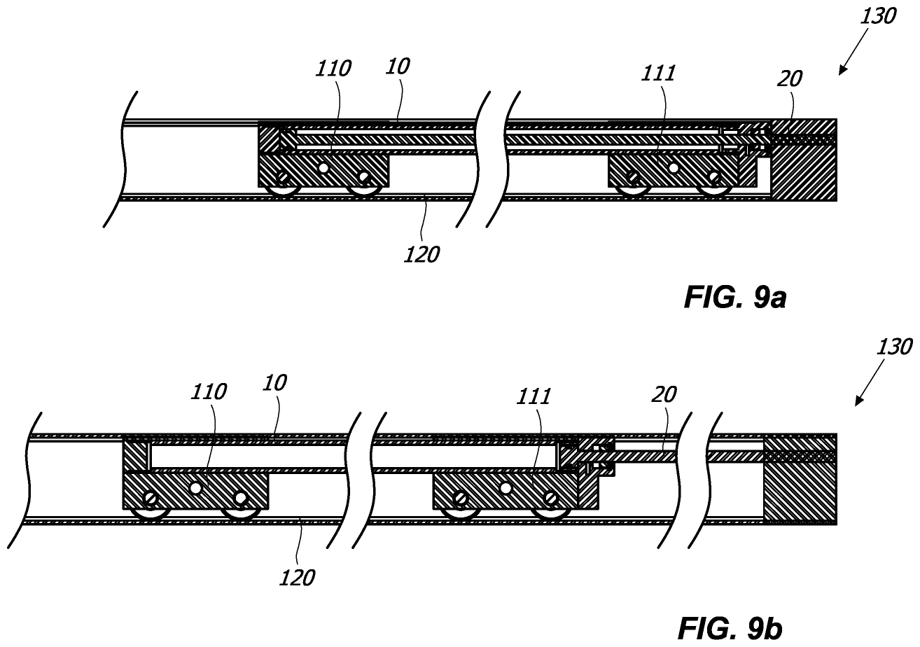

For example, the control means referred to above may be applied to a gas spring of a known type, or a gas spring of a known type may include these control means. In a further embodiment of the linear actuator 1, shown for example in FIGS. 6 and 7, the rest position of the end 22 may correspond to the distal position from the jacket 10 thereof, as shown for example in FIG. 6, while the working position of the end 22 may correspond to the position proximal to the jacket 10 thereof, as shown for example in FIG. 7.

In this embodiment, the compartment 18″ may be fluidically insulated and vacuum, while the compartment 18′ can be in fluid connection with the outside environment to remain at atmospheric pressure.

For this purpose, when the end 22 is in the rest position, the end cylinder 21 of the rod 20 may be abutting against the closing element 14, and in particular against a stop wall 14′ of the same, whereas when the end 22 is in the working position the end cylinder 21 of the rod 20 may remain spaced from the bottom wall 16 of the end cap 12 to free the opening 19″ of the duct 19.

In this way, when the end 22 is in the rest position, the volume and the pressure of the compartment 18″ are substantially zero.

This embodiment will work as opposed to that shown in FIGS. 1b to 5, and will therefore work in compression rather than in traction.

Once a user compresses the rod 20 from the extended rest position towards the retracted work position, in fact, the compartment 18″ will suck the same rod bringing it back into the rest position.

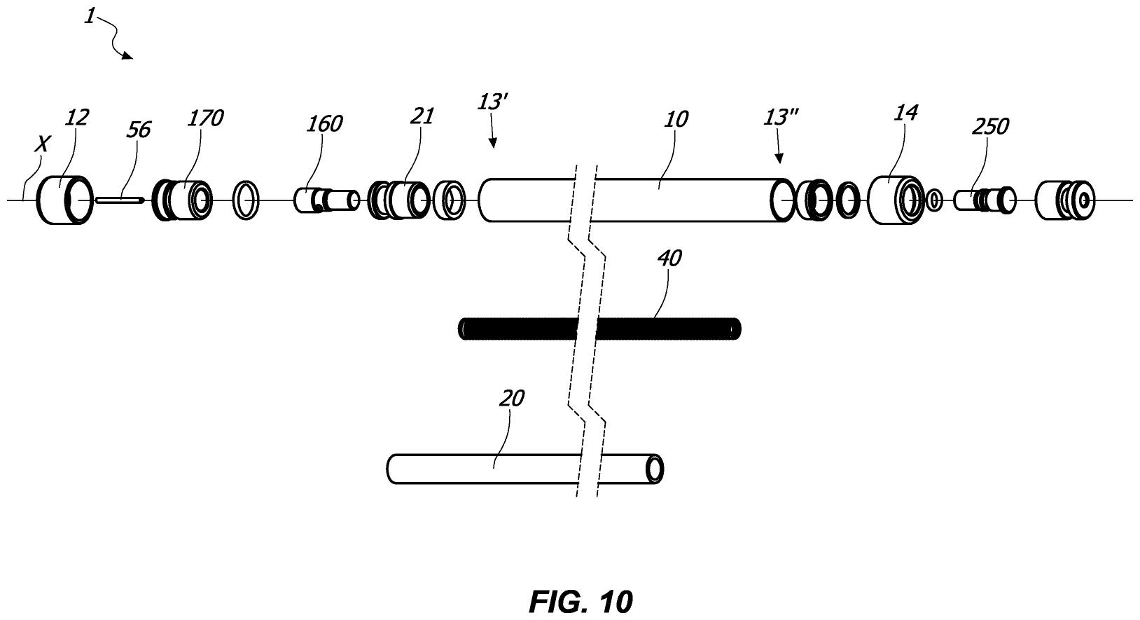

FIGS. 10 to 13B show further embodiments of the linear actuator 1, which can be used in the opening/closing system 100 described above.

More particularly, these embodiments are particularly suitable for the sliding movement of closing elements D of limited length, such as for example doors of a refrigerated counter or the doors of a shower box.

Even if in the rest of the description a linear actuator 1 is described for moving a sliding leaf D, it is understood that the linear actuator 1 may have any use without departing from the scope of protection of the appended claims.

As mentioned above, in the present description the notion of sliding of the rod 20 and the jacket 10 and the relative parts must be understood in a relative and not absolute manner. Therefore, even if for simplicity the sliding of the rod 20 with respect to the jacket 10 is to be cited, it must be understood that the sliding of these parts is reciprocal and relative to each other.

As evident from FIGS. 10 to 13B, the embodiments of the actuator 1 shown therein may have various characteristics in common with the embodiments shown in FIGS. 3 to 7.

Unless otherwise specified, therefore, it is intended that the characteristics described above in relation to the embodiments shown in FIGS. 3 to 7 are also present in the embodiments of FIGS. 10 to 13B.

As better specified in the rest of the present description, these last embodiments differ from those shown in FIGS. 3 to 7 for the presence of motion promoting means 40 of the rod from the working position to the rest position and of pneumatic or hydraulic damping means of this motion.

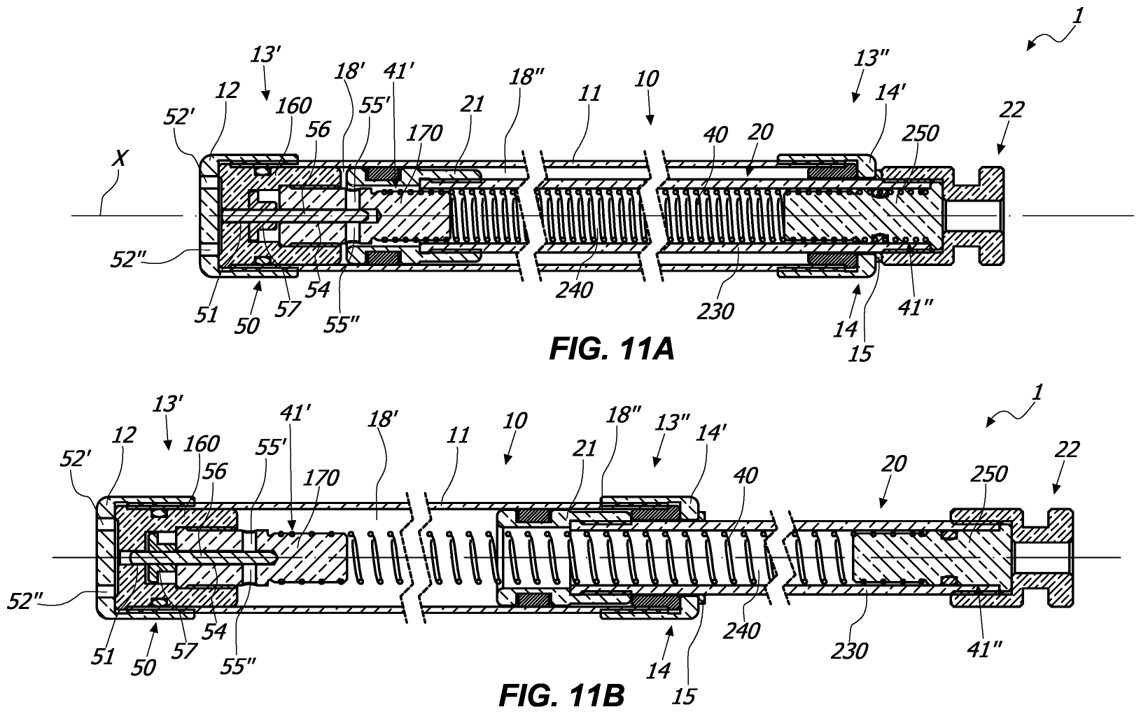

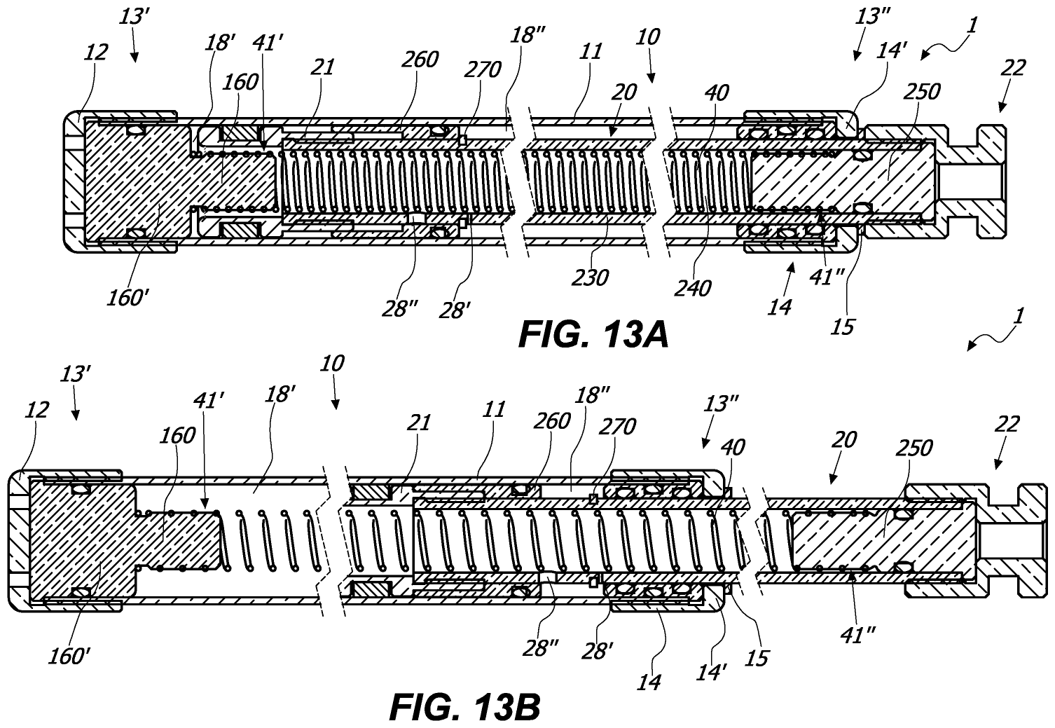

In the embodiments shown in FIGS. 11A and 13A, the linear actuator 1 is in the rest position, which may possibly, although not necessarily, correspond to the closed leaf D position.

On the other hand, in the embodiments shown in FIGS. 11B and 13B the linear actuator 1 is in the working position, which may possibly, though not necessarily, correspond to the fully or partially open leaf D position.

As mentioned above, in the embodiments of FIGS. 10 to 13B the linear actuator 1 may include motion promoting means, for example an elastic element 40 and more particularly a coil spring, operatively connected both with the jacket 10 and with the rod 20 to return the end 22 from the distal to the proximal position upon the movement of the same from the proximal to the distal position.

It is understood that even if for the rest of the present description reference is made to an elastic element 40, and more particularly to a coil spring, the linear actuator 1 may include any motion promoting means, for example hydraulic, magnetic or pneumatic. without thereby abandoning the scope of protection of the attached claims.

In a preferred but not exclusive embodiment, the rod 20 may be internally hollow, with a tubular wall 230 defining an inner chamber 240 which may house the coil spring 40.

There may also be means for the operative connection of the coil spring 40 respectively with the same jacket 10 and with the rod 20, for example respective threaded elements 160 and 250.

The threaded element 250 may be screwed into the rod 20 at the end 22, while the threaded element 160 may be screwed into the jacket 10 at the end 13′.

It is understood that in the embodiment of the linear actuator 1 shown in FIGS. 11A and 11B the threaded element 160 may be screwed into a hollow cap 170, screwed into the jacket 10 to provide a valve body, as better shown further on.

On the other hand, in the embodiment of the linear actuator 1 shown in FIGS. 13A and 13B the threaded element 160 can be screwed directly into the jacket 10, by means of a radially expanded portion 160′ thereof. It is evident that also in this case the threaded element 160 could be made in several pieces, as for example for the embodiment of FIGS. 4A and 4B.

In this way, the sliding of the end 22 from the proximal to the distal position will correspond to the loading of the spring 40, which will return the same end 22 towards the rest position.

By appropriately selecting the relative dimensions of the threaded elements 160, 250 and of the spring 40, it will be possible to mutually fix them in a simple and effective manner, making it extremely easy to mount the linear actuator 1.

In this case, in fact, it will be possible to screw the ends 41′ and 41″ of the spring 40 onto the elements 160 and 250, while ensuring a long lasting fixing.

Independently of the presence or absence of the coil spring 40, in the embodiments of FIGS. 10 to 13B, the jacket 10 may comprise damping means acting on the rod 20 to damp the movement of the end 22 upon its movement from the distal to the proximal position.

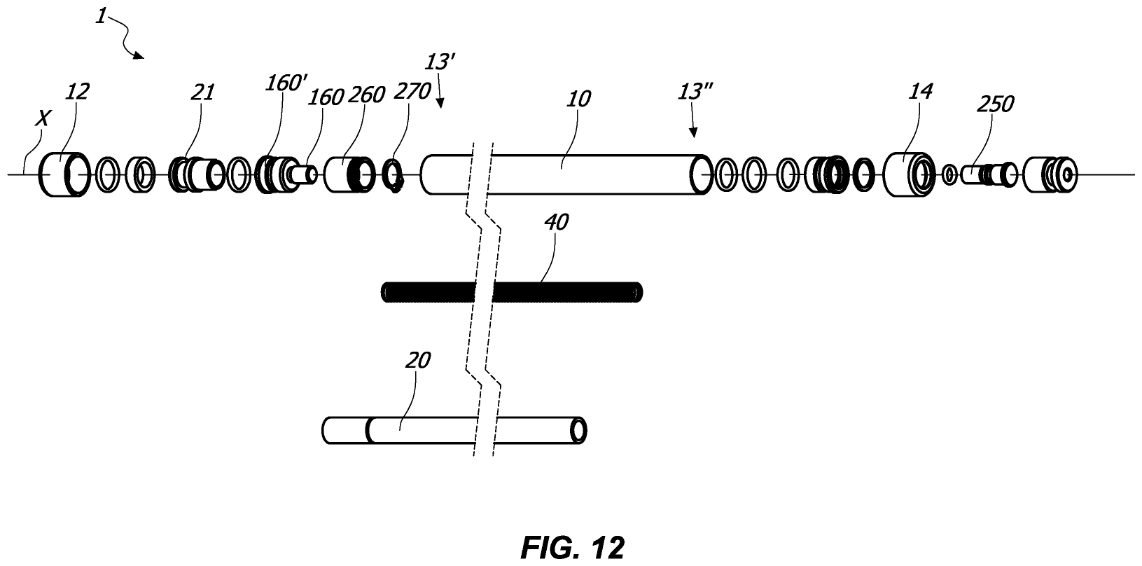

In the embodiment shown in FIGS. 10 to 11B the damping means may be of the pneumatic type, whereas in the embodiment shown in FIGS. 12 to 13B the damping means may be of hydraulic type.

In any case, the damping means may comprise a working fluid located in at least one of the variable volume compartments 18′, 18″. Regardless of its nature, therefore, the working fluid will act on the rod 20 damping its movement.

In particular, in the embodiment shown in FIGS. 10 to 11B the pneumatic working fluid, which in particular may be ambient air, is sucked into the compartment 18′ upon the movement of the end 22 from the proximal to the distal position.

The compartment 18′ then expands, filling with air, while the other compartment 18″ will contract and expel the air present in the external environment through the opening 15. In order to obtain the damping effect, the two compartments 18′, 18″ may be mutually isolated, that is fluidically non communicating to each other. On the other hand, each of the two compartments 18′, 18″ may be fluidically communicating with the outside environment.

Upon the movement of the end 22 from the distal to the proximal position, then, the air will be expelled from the compartment 18′ in a controlled manner, so as to obtain the damping effect.

In the embodiment shown in FIGS. 12 to 13B the hydraulic working fluid, which in particular can be oil, fills the whole jacket 10 and when the end 22 passes from the proximal to the distal position the hydraulic working fluid passes from the compartment 18″ to the compartment 18′.

The compartment 18′ therefore will expand by filling with oil, while the other compartment 18″ will contract by discharging the oil in it originally present in the same compartment 18′. In order to obtain the damping effect, the two compartments 18′, 18″ may be fluidically communicating with each other.

Upon the movement of the end 22 from the distal to the proximal position, then, the oil will be expelled from the compartment 18′ in a controlled manner to pass into the compartment 18″, so as to obtain the damping effect.

In order to obtain the controlled discharge of the working fluid, suitable control means may also be provided, which may comprise one cylindrical valve element 260 in the case of the embodiment with hydraulic working fluid shown in FIGS. 12 to 13B or valve means 50 in the case of the embodiment with pneumatic working fluid shown in FIGS. 10 to 11B.

In particular, with reference to the pneumatic embodiment shown in FIGS. 10 to 11B, the valve means 50 may comprise a valve body formed by the threaded element 160 and the hollow cap 170, which may present a first opening 51 in fluid communication with the outside environment through the openings 52′, 52″ practiced in the end cap 53 and a second opening 54 in fluid communication with the compartment 18′ through the two openings 55′, 55″.

This embodiment of the valve body is particularly advantageous, since in fact the threaded element 160 is both an integral part of the same valve body and a means for fixing the coil spring 40.

In the openings 51, 54 a passing-through pin 56 can be slidingly inserted, so that between each opening and the same pin 56 a calibrated hole having a suitable size to define the damping effect is defined. In this way, by appropriately choosing the relative dimensions of the pin 56 and the openings 51, 54 it will be possible to vary the damping effect.

The pin 56 may flow freely through the openings 51, 54, so as to keep it free from foreign bodies or dust.

A movable plug 57 may also be provided in the valve body between a first operating position, shown for example in FIG. 11B, away from the opening 51 in which the flow section for the oil entering the compartment 18′ may have a greater extension of the flow section for the oil coming out of the same compartment 18′ which is defined when the plug 57 is in a second operating position in contact with the first opening 51, shown for example in FIG. 11A.

On the other hand, with reference to the embodiment with oil shown in FIGS. 12 to 13B, the cylindrical valve element 260 may be inserted onto the rod 20 free to tightly slide along the axis X.

In particular, the cylindrical valve element 260 upon its moving along the axis X may come into contact with a stop ring 270 fitted on the tubular wall 230 and with the end cylinder 21.

More particularly, upon the movement of the end 22 from the distal to the proximal position, the cylindrical valve element 260 may come into contact with the stop ring 270 to be pushed towards the end 13′, as shown for example in FIG. 13A.

On the other hand, upon the reverse movement, the cylindrical valve element 260 may come into contact with the end cylinder 21 to be pushed towards the end 13″, as shown for example in FIG. 13B.

During this movement, the cylindrical valve element 260 will determine the resistance to the movement of the end 22 in both directions, that is, for example the resistant force that the user senses during the opening of the leaf D or the resistant force which opposes to which of the closing thereof.

For this purpose, along the tubular wall 230, a first port 28′ and a second port 28″ may be provided, the latter having significantly larger dimensions than the first, respectively interposed between the stop ring 270 and the end 22 and between the same stop ring 270 and the distal end 13′.

Both the ports 28′ and 28″ may put in fluid communication the compartment 18″ and the compartment 18′ through the internal chamber 240 of the rod 20.

During the movement of the cylindrical valve element 260, the stop ring 270 may prevent the same cylindrical valve element 260 from reaching the port 28′, keeping it always free.

On the other hand, upon the movement of the end 22 from the distal to the proximal position the stop ring 270 will push the cylindrical valve element 260 to selectively cover the port 28″, as shown for example in FIG. 13A.

Therefore, during this step the oil can pass exclusively through the port 28′, which being of very small dimensions will provide a small flow section for the oil and a corresponding high resistant force.

On the other hand, during the reverse movement, the oil can pass through both the ports 28′, 28″, thus providing a flow section for the oil much larger and therefore a corresponding minimum resistant force.

By suitably dimensioning the ports 28′, 28″ and appropriately spacing the same and the cylindrical valve element 260 it may be possible to vary the damping effect of the actuator 1.

Also in this case, in order to minimize the overall dimensions, the spring 40 may be placed in the inner chamber 240 of the rod 20.

From what has been described above, it is clear that the invention achieves the intended aims.

The invention is susceptible of numerous modifications and variations, all of which are within the inventive concept expressed in the appended claims. All the details may be replaced by other technically equivalent elements, and the materials may be different according to requirements, without departing from the scope of the invention.

Although the invention has been described with particular reference to the accompanying figures, the reference numbers used in the description and claims are used to improve the intelligence of the invention and do not constitute any limitation to the claimed scope of protection.

The invention claimed is:

1.-34. (canceled)

35. A system for automatically closing/opening an aperture, comprising:
a closing element slidable in a plane between a closed position, in which the aperture is closed, and an open position, in which the aperture is open;
a linear actuator operatively coupled to the closing element, the linear actuator automatically returning the closing element from one of the open or closed positions to the other one of the open or closed positions,
wherein the linear actuator comprises a jacket defining an axis and a rod slidable in relation to the jacket, the axis being substantially parallel to the plane, and
wherein the linear actuator comprises a stationary element and a movable element, the movable element including the jacket, the stationary element including the rod, the movable element of the linear actuator being mutually connected to the closing element and sliding along the axis; and
a guide rail in which the movable element of the linear actuator is enabled to slide, the guide rail defining a sliding direction substantially parallel to the axis,
wherein the movable element of the linear actuator includes a slider operatively sliding along the guide rail, the slider including at least one pair of slides coupled to the jacket,
wherein the rod has an end cylinder inserted into the jacket and an opposite end external to the jacket and slidable along the axis or an axis parallel thereto between a position proximal to the jacket and a position distal therefrom, the end cylinder dividing the jacket into a first and a second variable volume compartments, and
wherein either:
the jacket comprises a biasing member acting on the rod to move the opposite end in relation to the jacket from one of the distal or the proximal positions to the other one of the distal or the proximal positions upon a movement of the opposite end from the other one of the distal or the proximal positions to the one of the distal or the proximal positions;
or
one of the first or the second variable volume compartments is fluidly insulated and under vacuum, the other one of the first or the second variable volume compartments being fluidly communicating with an outside environment, so that upon the movement of the opposite end from the proximal position to the distal position the one of the first or the second variable volume compartments causes the rod under vacuum, thus returning the opposite end from the distal position to the proximal position.

36. The system according to claim 35, further comprising a hollow elongated profile including the guide rail, the linear actuator being concealed within the elongated profile.

37. The system according to claim 36, wherein the closing element (D) further comprises a frame, the hollow elongated profile being inserted within the frame or being an integral part thereof.

38. The system according to claim 36, wherein the hollow elongated profile is positioned above the closing element.

39. The system according to claim 35, wherein, upon the movement of the opposite end from the proximal position to the distal position, one of the first or the second variable volume compartments expands, the closing element being in the closed position when the one of the first or the second variable volume compartments has a minimum volume.

40. The system according to claim 39, wherein the minimum volume of the one of the first or the second variable volume compartments is substantially zero.

41. The system according to claim 35, wherein the biasing member is operatively connected to the jacket and to the rod, and causes the opposite end to return from the distal position to the proximal position upon the movement of the opposite end from the proximal position to the distal position.

42. The system according to claim 35, wherein the biasing member comprises an elastic element operatively connected to the jacket and to the rod, the rod being internally hollow, the elastic element being positioned within the rod.

43. The system according to claim 42, wherein the elastic element is operatively connected to the jacket and to the rod to bring the opposite end from the distal position to the proximal position upon the movement of the opposite end from the proximal position to the distal position.

44. The system according to claim 35, wherein the jacket further comprises damping member acting on the rod, the damping member damping the movement of the opposite end upon the movement of the opposite end from the one of the distal or the proximal positions to the other one of the distal or proximal positions.

45. The system according to claim 44, wherein the damping member comprises a working fluid placed in at least one of the first or the second variable volume compartments.

46. The system according to claim 45, wherein, upon the movement of the opposite end from the one of the distal or the proximal positions to the other one of the distal or the proximal positions, one of the first or the second variable volume compartments expands by filling at least partially with the working fluid, and the other one of the first or the second variable volume compartments contracts, and wherein, upon the movement of the opposite end from the other one of the distal or the proximal positions to the one of the distal or the proximal positions, the other one of the first or the second variable volume compartments expands and the one of the first or the second variable volume compartments contracts, so that the working fluid at least partially flows out, the damping member further including means for controlling an outflow of the working fluid.

47. The system according to claim 45, wherein the working fluid is a hydraulic fluid, the first and the second variable volume compartments being in fluid communication via a fluidic connecting line, so that an inflow of the hydraulic fluid into the one of the first or the second variable volume compartments corresponds to an outflow of the hydraulic working fluid from the other one of the first or the second variable volume compartments and vice-versa, the fluidic connecting line comprising at least one first port.

48. The system according to claim 45, wherein the working fluid is a pneumatic fluid, the first and the second variable volume compartments being fluidly non-communicating with each other and each of the first and the second variable volume compartments being fluidly communicating with the outside environment.

49. The system according to claim 35, wherein the linear actuator comprises control means that control an air flow flowing into or out of the other one of the first or the second variable volume compartments, so as to control a force required to open the closing element (D) and/or a closing speed thereof, the control means comprising:
a first and a second connection line that fluidly connect the other one of the first or the second variable volume compartments with the outside environment; and
a valve selectively acting on one of the first or the second connection lines to open the first connection line or the second connection line upon the movement of the end cylinder from the rest position to the working position and to fill the first connection line or the second connection line upon a reverse movement, so as to force the air to flow into the other one of the first or the second variable volume compartments through the other one of the first or the second connection lines.
